(19) United States
(12) Patent Application Publication
(10) Pub. No.: US 2008/0241578 A1
(43) Pub. Date: Oct. 2, 2008

(54) Halogen-free flame retardant epoxy resin composition, prepreg, and copper clad lamination

(75) Inventors: Hsueh-Tso Lin, Taipei City (TW); Chung-Yu Chan, Taipei City (TW); Kuan-Ching Chen, Taipei City (TW); Dick Zhong, Taipei City (TW)

Correspondence Address: BIRCH STEWART KOLASCH & BIRCH, PO BOX 747, FALLS CHURCH, VA, 22040-0747, US

(73) Assignee: GRAND TEK ADVANCE MATERIAL SCIENCE CO., LTD.

(21) Appl. No.: 11/896,089

(22) Filed: Aug. 29, 2007

(30) Foreign Application Priority Data
Mar. 28, 2007 (TW) 96110717

(51) Int. Cl. B32B 15/092; C09K 21/06

(52) U.S. Cl. 428/626; 252/609

(57) ABSTRACT

Disclosed is an epoxy resin composition featured by comprising a phosphate with phenolic or benzoxazine groups for enhancing flame retardancy. The phosphate used herein has higher molecular weight and higher viscosity than conventional ones. Because the phosphate is able to react with the epoxy resin at high temperatures, greater amounts of phosphate can be added to the epoxy resin to increase the viscosity of the epoxy resin prepreg for copper clad laminates or printed circuit plates.

### BACKGROUND OF THE INVENTION

1. Field of the Invention

The present invention relates to an epoxy resin composition utilized in copper clad laminate, and in particular relates to a halogen-free flame retardant epoxy resin composition comprising a phosphate reacting with epoxy resin.

2. Description of the Related Art

Epoxy resin has numerous properties such as an electrical specification property, a volume stability property, a thermal retardancy property, a chemical resistance property, and an adhesion property. Thus, epoxy resin is widely applied in many industries. For example, epoxy resin can be applied as a protective coating, an adhesive agent, a sealing material for integrated circuit, or a composite. In copper clad laminate, epoxy resin plays an important role as a composite. In the 1960's, tetrabromo bisphenol A (TBBA) was introduced in epoxy resin to improve flame retardancy. The halogen compound, despite efficiently improving the flame retardancy of the epoxy resin, also releases toxic chemicals such as dioxin and/or furan when burning. Therefore, the halogen compound was replaced by a halogen-free compound to produce halogen-free flame retardants.

In U.S. Pat. Nos. 6,646,064, 6,645,631, 6,797,821, 6,291,626, 6,291,627, 6,900,269, 6,524,709, and 6,645,630, phosphorus element-containing compounds such as 10-dihydro-9-oxa-10-phosphahenanthrene-10-oxide (hereinafter DOPO) and 10-(2′,5′-dihydroxyphenyl)-9,10-dihydro-9-oxa-10-phosphahenanthrene-10-oxide (hereinafter DOPO-HQ), or derivatives thereof were used to replace the halogen compound. DOPO or DOPO-HQ first reacts with epoxy resin to form a bi-functional or multi-functional epoxy resin. The formula for DOPO (Formula 1) and DOPO-HQ (Formula 2) are shown as follows:

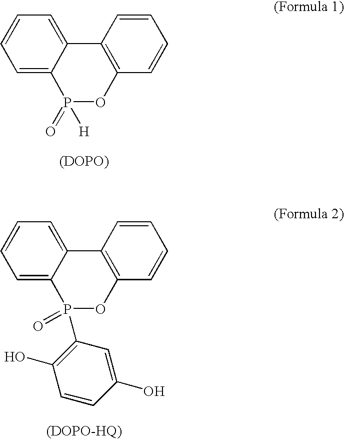

In EP Pat. No. 0384940 and 0408990, phosphorus element-containing compound is also used to react with epoxy resin to form a bi-functional or multi-functional epoxy resin. The phosphorous-containing modified epoxy resin is of relatively higher costs, and U.S. Pat. No. 6,353,080 acknowledges this drawback. In U.S. Pat. No. 6,534,601, the bi-functional epoxy resin is first reacted with DOPO-HQ and then silicone resin to enhance flame retardancy, however, the problem of relatively higher costs still existed.

In efforts to improve the flame retardancy of epoxy resin, phosphorus and nitrogen element-containing compounds serve as introductory curing agents to react with epoxy resin for other epoxy resin modifications. In U.S. Pat. No. 6,613,848, DOPO derivatives react with phenol novolac resin or melamine phenol novolac resin to form phosphorous or nitrogen-containing phenolic resins, respectively, serving as curing agents. In U.S. Pat. No. 6,797,821, an active-hydrogen containing phosphorous and nitrogen compound serves as a curing agent to enhance the flame retardancy of the epoxy resin.

For reducing the cost, DOPO, DOPO-HQ, or other phosphorous-containing epoxy resin can be replaced with commercially available phosphates. In U.S. Pat. No. 6,500,546, the epoxy resin formulae comprise DOPO and phosphate EXOLIT OP910 (commercially available from CLARIANT) to enhance flame retardancy. The formula for EXOLIT OP910 is shown as Formula 3 as follows:

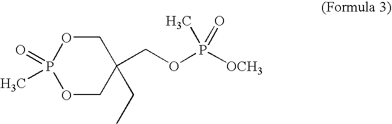

Copolymers of polystyrene, maleic acid, and maleic anhydride can also serve as curing agents. In U.S. Pat. No. 6,353,080, phosphates such as Amgard™ P45 or Amgard™ V19 (commercially available from Albright and Wilson Ltd.) react with nitrogen-containing novolac epoxy resin. Therefore, a nitrogen-containing crosslink agent having at least two amino groups is introduced as a curing agent, thereby enhancing the flame retardancy of the epoxy resin.

In U.S. Pat. Nos. 5,955,184 and 6,214,455, the curing agent is nitrogen-containing or nitrogen/phosphorous-containing phenolic resin which combines with inorganic fillers such as aluminum hydroxide, magnesium hydroxide, talc, silicone dioxide, and etc. After cured, the above combination reaches UL 94V0 level (Standard for Flame Arresters).

Phosphate is a general flame retardant such as the previously described EXOLIT OP910, Amgard™ P45, and Amgard™ V19. Meanwhile, phosphate includes resorcinol bis-diphenyl phosphate (hereinafter RDP) such as Fyrolflex RDP (commercially available from AKZO Nobel), bisphenol A bis-diphenyl phosphate (hereinafter BDP) such as Fyrolflex BDP (commercially available from AKZO Nobel), and triphenyl phosphate (hereinafter TPP) such as Fyrolflex TPP (commercially available from AKZO Nobel). Besides TPP, both of the commercially available RDP and BDP are viscoid liquid. While RDP has better flame retardancy than BDP, BDP has better hydrolysis resistant than RDP. Note that RDP, BDP, and TPP cannot react with epoxy resin, such that the epoxy resin composition containing the described flame retardants have lower viscosity. By impregnating a glass cloth to the previously described epoxy resin composition and baking it, a prepreg will be formed with low viscosity. Due to the low viscosity, during the following laminating process, high resin flow will occur such that the laminating window is narrower making the process harder to control. Therefore, resulting in a laminate with uneven thickness, insufficient thickness, and white edges/corners. On the other hand, RDP, BDP, and TPP have lower flame retardancy and heat resistance compared to conventional halogen-containing epoxy resin or high cost phosphorous/nitrogen-containing epoxy resin. Accordingly, a halogen-free flame retardant epoxy resin composition which is able to solve the above problems is desired.

### SUMMARY OF THE INVENTION

The invention provides a halogen-free flame retardant epoxy resin composition, comprising (a) 25 to 45 weight percent of novolac epoxy resin; (b) 18 to 35 weight percent of phosphate; (c) 10 to 20 weight percent of nitrogen-containing phenolic resin, comprising amino triazine novolac resin, benzoxazine resin, or combinations thereof; and (d) 20 to 45 weight percent of inorganic filler; wherein the phosphate has formulae:

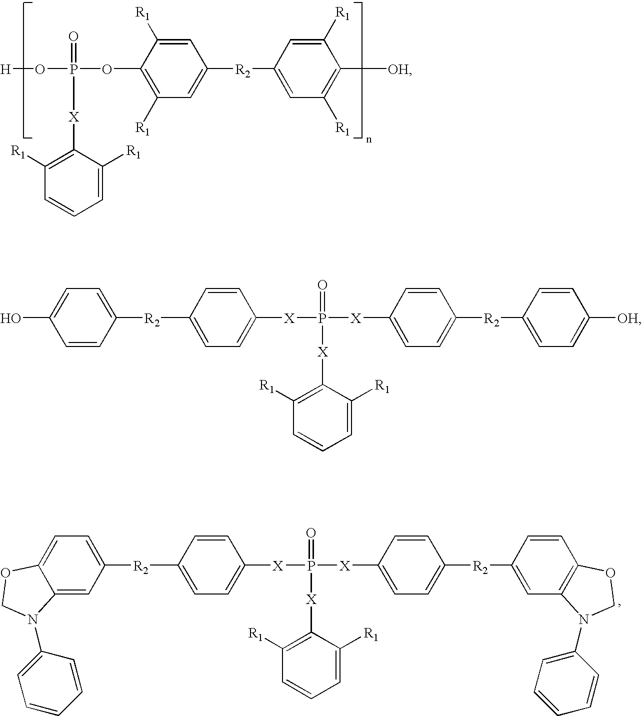

or combinations thereof; wherein n is an integral from 4 to 10; each R₁ is independently selected from hydrogen or methyl; each R₂ is independently selected from isopropyl or sulfonyl; and each X is independently selected from oxygen or single bond.

The invention also provides a prepreg prepared by impregnating a prepreg to the epoxy resin composition.

The invention further provides a copper clad laminate prepared by laminating a copper foil and the prepreg.

A detailed description is given in the following embodiments with reference to the accompanying drawings.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

For improving the flame retardancy of the epoxy resin, an embodiment of the invention provides a phosphate, with phenolic or benzoxazine functional groups, having higher molecular weight and viscosity than commercially available BDP. The described phosphate reacts with epoxy resin at high temperatures, such that a greater amount is added compared with general flame retardants of the like. The prepreg utilizing the same, applied in copper clad laminate and printed circuit plates, has higher viscosity.

One embodiment of the invention provides a halogen-free flame retardant epoxy resin composition, comprising (a) 25 to 45 weight percent of novolac epoxy resin, (b) 18 to 35 weight percent of phosphate, (c) 10 to 20 weight percent of nitrogen-containing phenolic resin, comprising amino triazine novolac resin, benzoxazine resin, or combinations thereof, and (d) 20 to 45 weight percent of inorganic filler. The phosphate in Formulae 4, 5 and 6 are shown as follows:

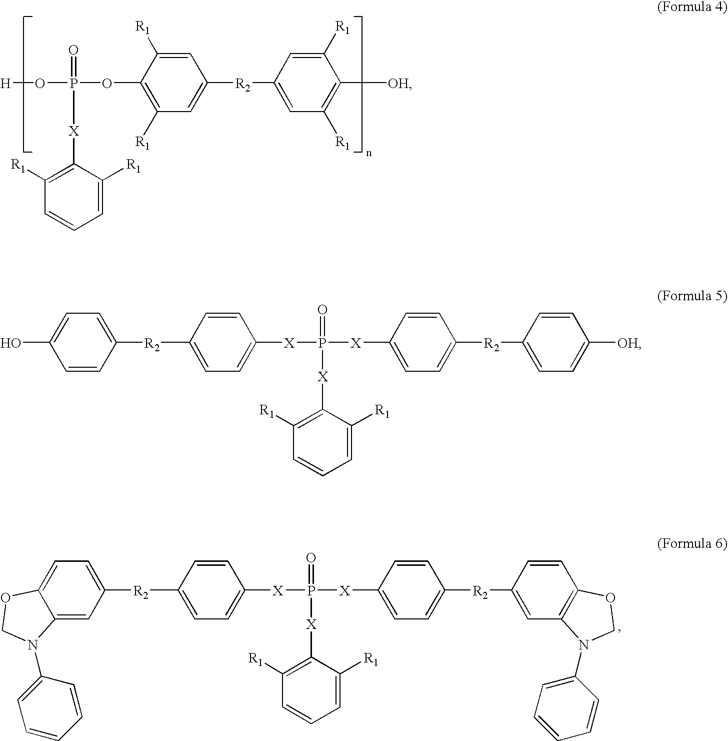

or combinations thereof.

n is an integral from 4 to 10. Each R₁ is independently selected from hydrogen or methyl, each R₂ is independently selected from isopropyl or sulfonyl, and each X is independently selected from oxygen or single bond.

The (a) novolac epoxy resin is mostly formed by reaction of novolac resin and epichlorohydrin, such as D.E.N.™ series (commercially available from DOW Chemicals), CNE series such as CNE 200ELF and CNE 202ELF (commercially available from Chang Chun Chemical Co., Ltd. Company), and NPCN series such as NPCN-703 and NPCN-704 (commercially available from Nanya Plastic Corp. Co., Ltd.). The novolac epoxy resin has a formula as shown in Formula 7 as follows:

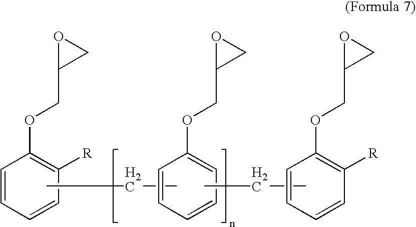

In Formula 7, each R is independently selected from hydrogen or methyl.

The softening point of general novolac epoxy resins is of about 70° C. to 130° C., and the softening point of the novolac epoxy resin of one embodiment of the invention is at about 75° C. to 100° C. Furthermore, the epoxy equivalent value of the novolac epoxy resin is about 190 to 240. The novolac epoxy resin occupies 25 to 45 weight percent of the epoxy resin composition, and preferably occupies 30 to 40 weight percent of the epoxy resin composition.

The (b) phosphate in the embodiments may utilize Formulae 4 or 5 synthesized by condensation of bisphenol A/bisphenol sulfonyl derivatives and phenoxy dichlorophosphatel phenyl phosphonic dichloride. Compared with commercially available BDP, the phosphates with Formulae 4 or 5 have several advantages as follows. First, the phosphates have terminal phenol functional groups which react with epoxy resin at high temperatures. Second, the phosphates are solid at room temperature, and have a higher heat resistance as compared to BDP. Third, the phosphates have higher viscosity than BDP. For example, the phosphates with Formulae 4 or 5 have a viscosity of 20000 to 25000 cps at 100° C., while BDP has a viscosity of only 40 to 100 cps at 100° C. As such, a greater amount of phosphate of Formulae 4 or 5 can be added to the epoxy resin as compared to standard BDP.

In addition, the (b) phosphate in the embodiments may utilize formula 6, in which the benzoxazine groups are formed by reaction of phenol compound, formaldehyde, paraformaldehyde, and aniline. The benzoxazine groups will process ring-opening polymerization after heating to form polybenzoxazine. The ring-opening polymerization of the phosphate with Formula 6 is shown in Formula 8 as below. The phenol groups formed by ring-opening may react with epoxy resin.

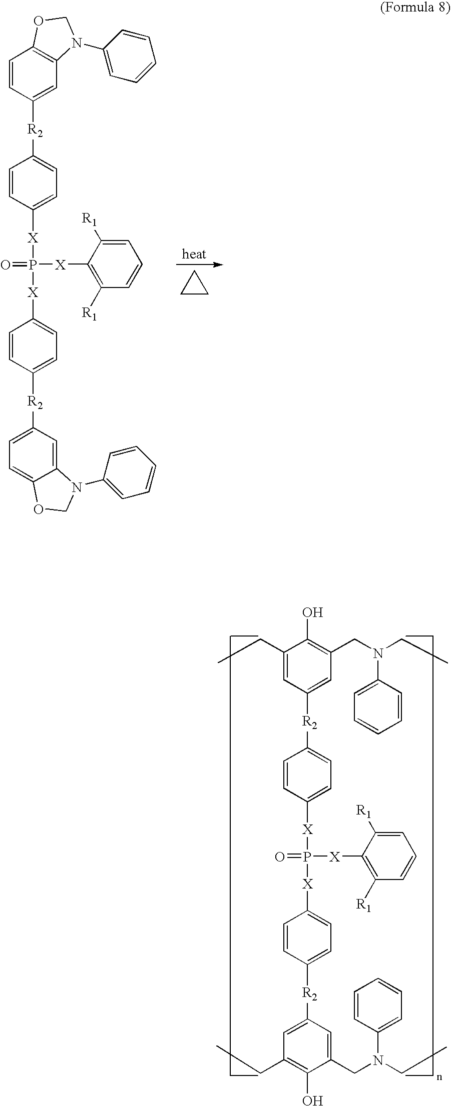

The phosphates with Formulae 4, 5, and 6 can be utilized alone or in combination. The phosphates have a phosphorous content of 1.40 to 2.73 weight percent of the epoxy resin composition, and have a more preferably phosphorous content of 1.40 to 2.34 weight percent of the epoxy resin composition.

The (c) nitrogen-containing phenolic resin in the embodiments can be amino triazine novolac (ATN) resin, benzoxazine resin, or combinations thereof. ATN can be synthesized by condensation polymerization of phenol, melamine/benzoguanamine, and formaldehyde. The nitrogen-containing phenolic resin includes LA-7751, LA-1356, and LA-1398 (commercially available from Dinippon ink and chemicals Incorporated). ATN has a formula as shown in Formula 9 as follows:

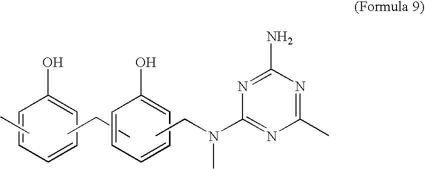

For example, LA-7751 has a nitrogen content of 14 weight percent of itself, a hydroxyl equivalent value of 135, and a solid content of 57 to 61 percent in methyl ethyl ketone.

Besides the described ATN, the (c) nitrogen-containing phenolic resin in the embodiments include benzoxazine of bisphenol A resin, benzoxazine of bisphenol F resin, benzoxazine of bisphenol sulfonyl resin, benzoxazine of novolac resin, or combinations thereof. The described benzoxazine will form nitrogen-containing phenolic resin after heating.

In one embodiment, the content ratio of the (c) nitrogen-containing phenolic resin is according to a ratio of the epoxy group of the epoxy resin composition and the hydroxyl group of the nitrogen-containing phenolic resin. For example, the epoxy group of the epoxy resin composition and the hydroxyl group of the nitrogen-containing phenolic resin have a ratio of 1:0.3 to 1:1.1, and preferably of 1:0.4 to 1:0.8. The nitrogen-containing phenolic resins have a nitrogen content of 1.40 to 2.80 weight percent of the epoxy resin composition, and preferably of 1.50 to 2.52 weight percent of the epoxy resin composition.

The (d) inorganic filler in embodiments includes silicone dioxide, aluminum hydroxide, magnesium hydroxide, aluminum oxide, clay, or mica. The inorganic filler occupies 20 to 45 weight percent of the epoxy resin, preferably of 25 to 36 weight percent of the epoxy resin composition. For evenly dispersing the inorganic filler in the epoxy resin composition, strong stirring or other suitable dispersing method can be applied. After dispersing, the unevenly dispersed particles are removed by filtering through a 100-200 mesh filter screen.

Except for the previously described compositions, one embodiment of the invention optionally adds bisphenol A epoxy resin as shown in Formula 10 as follows:

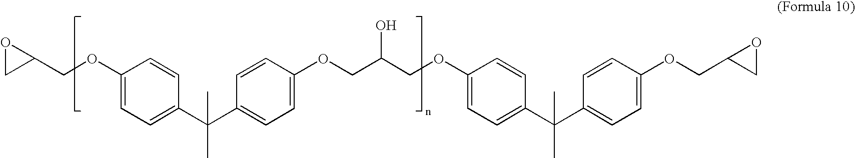

The bisphenol A epoxy resin includes DER-331 series (commercially available from DOW Chemical), Epikote 828 series (Commercially available from Shell Chemical Company), BE-188 series (Commercially available from Chang Chun Chemical), or NPES-301 series (commercially available from Nanya Plastic Corp. Co., Ltd.). In one embodiment of the invention, the bisphenol A epoxy resin has an epoxy equivalent value of less than or equal to 1000. The bisphenol A epoxy resin occupies less than 5 weight percent of the epoxy resin composition. The bisphenol A epoxy resin can be a single epoxy equivalent value resin, a mixture or different epoxy equivalent value resins.

The previous described epoxy resin compositions are diluted, and then impregnated or coated on a glass cloth. The glass cloth is subsequently dry baked to form a prepreg. The diluents can be propylene glycol monomethyl ether acetate (PMA), propylene glycol monoethyl ether (PM), methyl ethyl ketone, acetone, or combinations thereof. The dry baking is processed at 170° C. to 220° C. for 3 to 5 minutes.

The described prepregs can be stacked and laminated to form a laminated sheet, the lamination temperature is about 140° C. to 200° C., and the lamination pressure is about 200 psi to 450 psi. The manufacturing of a copper clad laminate is similar to that of a laminated sheet. The difference is one or both sides of the prepreg stack is/are disposed copper foils and then laminated. In addition, a patterned circuit board can be disposed between the layers of the prepreg stack, the copper foil/foils is/are disposed on one or both sides of the prepreg stack, and laminated to form a multi laminated sheet. The lamination temperature is about 160° C. to 190° C.

### EXAMPLES AND COMPARATIVE EXAMPLES

The name, description and source of the chemicals utilized in the following Examples and Comparative Examples are listed below:

(1) Bisphenol A Epoxy Resin

BE-188, commercially available from Chang Chun Chemical, has an epoxy equivalent value of 185 to 195 and a solid content of 100 percent.

(2) Novolac Epoxy Resin

CNE-200ELF, commercially available from Chang Chun Chemical, has an epoxy equivalent value of 190 to 210, a softening point of 76° C. to 82° C., and a solid content of 100 percent.

(3) Bisphenol A bis(diphenyl phosphate)

Fyroflex BDP, commercially available from AKZO Nobel, is a liquid having a phosphorous content of 9 weight percent thereof with formula as Formula 11.

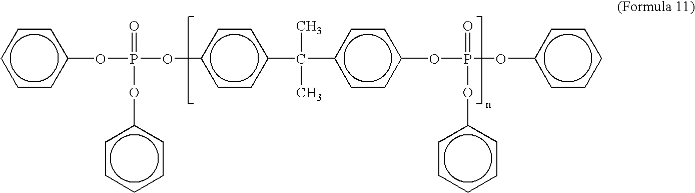

(4) Resorcinol bis(diphenyl phosphate)

Fyroflex RDP, commercially available from AKZO Nobel, is a liquid having a phosphorous content of 10.9 weight percent thereof with a formula as Formula 12.

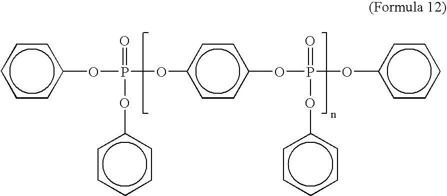

(5) Triphenyl Phosphate

Fyroflex TPP, commercially available from AKZO Nobel, is a solid having a phosphorous content of 9.5 weight percent thereof with a formula as Formula 13.

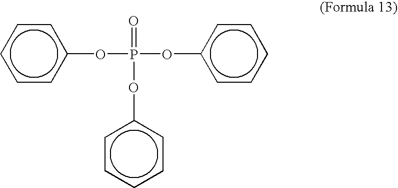

(6) Poly Phosphate with Terminal Phenol Group (PBDP1)

PBDP1, commercially available from TSI Company Limited in China, is a solid having a phosphorous content of 7.8 weight percent thereof with a formula as Formula 14. PBDP1 has a terminal phenol group to react with epoxy groups of epoxy resins.

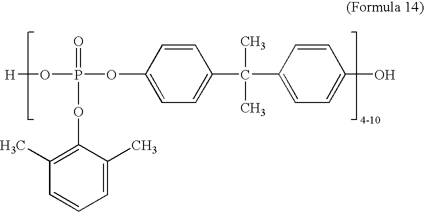

(7) Phosphate with Terminal Phenol Groups (BDPI)

BDPI, commercially available from TSI Company Limited in China, is a solid having a phosphorous content of 5.2 weight percent thereof with a formula as Formula 15. BDPI has terminal phenol groups to react with epoxy groups of epoxy resins.

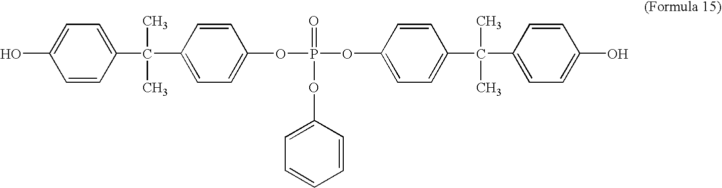

(8) Amino Triazine Novalac (ATN)

LA-7751, commercially available from Dai Nippon Ink Chemical Co., Ltd., has a nitrogen content of 14 weight percent thereof, a solid content of 57 to 61 percent, and a hydroxyl equivalent value of 135.

(9) Benzoxazine of Bisphenol A Epoxy Resin

BZ-4, commercially available from K.L. CHEMICALS CO., LTD. in Taiwan, is a solid.

(10) Aluminum Hydroxide

CL-303, commercially available from SUMITOMO CHEMICAL Co., Ltd. in Japan, has a particle radius of 2.5 μm.

(11) Silicone Dioxide

SilverBond 925, commercially available from Bao-Lin Industrial Co., Ltd., has a particle radius of 3 μm.

Synthesis of Benzoxazine Phosphate

180 g of BDPI, 38.3 g of paraformaldehyde, 55.9 g of aniline, and 92 g of methyl ethyl ketone were charged in a round bottom flask and refluxed at 80° C. to 90° C. for 8 hours under nitrogen. The remaining reactants such as paraformaldehyde, aniline, and methyl ethyl ketone were removed by a rotary evaporator, such that a benzoxazine phosphate with Formula 16 as shown below was formed. Finally, the benzoxazine phosphate was diluted with 114 g of methyl ethyl ketone, and the diluents had a solid content of 70 percent.

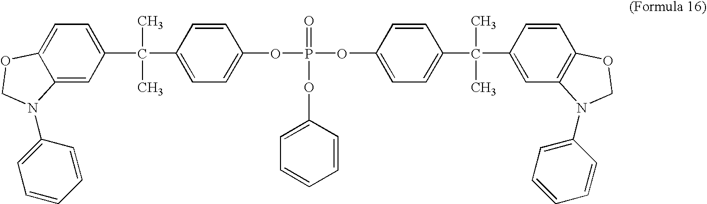

### Example 1

4270 g of CNE-200ELF (70 percent solid content in PMA), 330 g of BE-188, 2800 g of PBDP1 (70 percent solid content in methyl ethyl ketone), 1000 g of methyl ethyl ketone, 1300 g of LA-7751 (59 percent solid content in methyl ethyl ketone), 930 g of BZ-4 (60 percent solid content in methyl ethyl ketone), and 2400 g of aluminum hydroxide (CL-303) were mixed by strong stirring for 6 hours and then diluted with PMA. The diluents had a solid content of 65 percent. The diluents were subsequently filtered by a 100 to 200 mesh filter screen. A glass cloth was impregnated in the filtrate by a dipping machine and then dry baked to form a prepreg.

### Example 2

4270 g of CNE-200ELF (70 percent solid content in PMA), 330 g of BE-188, 2800 g of PBDP1 (70 percent solid content in methyl ethyl ketone), 1000 g of methyl ethyl ketone, 1600 g of LA-7751 (59 percent solid content in methyl ethyl ketone), 930 g of BZ-4 (60 percent solid content in methyl ethyl ketone), 600 g of benzoxazine phosphate with Formula 16 (70 percent solid content in methyl ethyl ketone), and 2700 g of silicone dioxide (SilverBond 925) were mixed by strong stirring for 6 hours and then diluted with PMA. The diluents had a solid content of 65 percent. The diluents were subsequently filtered by a 100 to 200 mesh filter screen. A glass cloth was impregnated in the filtrate by a dipping machine and then dry baked to form a prepreg.

### Example 3

4500 g of CNE-200ELF (70 percent solid content in PMA), 3930 g of PBDP1 (70 percent solid content in methyl ethyl ketone), 1000 g of methyl ethyl ketone, 1570 g of LA-7751 (59 percent solid content in methyl ethyl ketone), 830 g of BZ-4 (60 percent solid content in methyl ethyl ketone), 1400 g of aluminum hydroxide (CL-303), and 1400 g of silicone dioxide (SilverBond 925) were mixed by strong stirring for 6 hours and then diluted with PMA. The diluents had a solid content of 65 percent. The diluents were subsequently filtered by a 100 to 200 mesh filter screen. A glass cloth was impregnated in the filtrate by a dipping machine and then dry baked to form a prepreg.

### Example 4

4500 g of CNE-200ELF (70 percent solid content in PMA), 2800 g of PBDP1 (70 percent solid content in methyl ethyl ketone), 1070 g of methyl ethyl ketone, 1600 g of LA-7751 (59 percent solid content in methyl ethyl ketone), 1105 g of BZ4 (60 percent solid content in methyl ethyl ketone), 1155 g of aluminum hydroxide (CL-303), and 2310 g of silicone dioxide (SilverBond 925) were mixed by strong stirring for 6 hours and then diluted with PMA. The diluents had a solid content of 65 percent. The diluents were subsequently filtered by a 100 to 200 mesh filter screen. A glass cloth was impregnated in the filtrate by a dipping machine and then dry baked to form a prepreg.

### Comparative Example A

4270 g of CNE-200ELF (70 percent solid content in PMA), 596 g of BE-188, 1240 g of Fyroflex RDP, 1670 g of methyl ethyl ketone, 1184 g of LA-7751 (59 percent solid content in methyl ethyl ketone), 100 g of BZ-4 (60 percent solid content in methyl ethyl ketone), 1260 g of aluminum hydroxide (CL-303), and 1260 g of silicone dioxide (SilverBond 925) were mixed by strong stirring for 6 hours and then diluted with PMA. The diluents had a solid content of 65 percent. The diluents were subsequently filtered by a 100 to 200 mesh filter screen. A glass cloth was impregnated in the filtrate by a dipping machine and then dry baked to form a prepreg.

### Comparative Example B

4270 g of CNE-200ELF (70 percent solid content in PMA), 596 g of BE-188, 1240 g of Fyroflex RDP, 1670 g of methyl ethyl ketone, 1184 g of LA-7751 (59 percent solid content in methyl ethyl ketone), 100 g of BZ-4 (60 percent solid content in methyl ethyl ketone), and 2520 g of aluminum hydroxide (CL-303) were mixed by strong stirring for 6 hours and then diluted with PMA. The diluents had a solid content of 65 percent. The diluents were subsequently filtered by a 100 to 200 mesh filter screen. A glass cloth was impregnated in the filtrate by a dipping machine and then dry baked to form a prepreg.

### Comparative Example C

4270 g of CNE-200ELF (70 percent solid content in PMA), 937 g of Fyroflex TPP, 1300 g of methyl ethyl ketone, 1256 g of LA-7751 (59 percent solid content in methyl ethyl ketone), and 2530 g of aluminum hydroxide (CL-303) were mixed by strong stirring for 6 hours and then diluted with PMA. The diluents had a solid content of 65 percent. The diluents were subsequently filtered by a 100 to 200 mesh filter screen. A glass cloth was impregnated in the filtrate by a dipping machine and then dry baked to form a prepreg.

### Comparative Example D

4270 g of CNE-200ELF (70 percent solid content in PMA), 1240 g of Fyroflex BDP, 1490 g of methyl ethyl ketone, 1256 g of LA-7751 (59 percent solid content in methyl ethyl ketone), 100 g of BZ-4 (60 percent solid content in methyl ethyl ketone), and 2700 g of aluminum hydroxide (CL-303) were mixed by strong stirring for 6 hours and then diluted with PMA. The diluents had a solid content of 65 percent. The diluents were subsequently filtered by a 100 to 200 mesh filter screen. A glass cloth was impregnated in the filtrate by a dipping machine and then dry baked to form a prepreg.

Manufacture of a Copper Clad Laminate

Eight prepregs such as those described in Examples 1-4 and Comparative Examples A-D were stacked, respectively. Each side of the prepreg stacks was charged a copper foil and then laminated by a laminating machine. The lamination temperature was 190° C., the lamination pressure was 400 psi, and the lamination period was 90 minutes.

Table 1 shows the recipe and the properties of copper clad laminates utilizing the prepregs from Examples 1-4 and Comparative Examples A-D, respectively. In Table 1, most of the measurements are according to ICP standards as shown in Table 2, following Table 1.

TABLE 1

| | | | | | Comparative | Comparative | Comparative | Comparative |
|---|---|---|---|---|---|---|---|---|
| | Example 1 | Example 2 | Example 3 | Example 4 | Example A | Example B | Example C | Example D |
| CNE 200ELF | 4270 | 4270 | 4500 | 4500 | 4270 | 4270 | 4270 | 4270 |
| BE-188 | 330 | 330 | — | — | 596 | 596 | — | — |
| Methyl ethyl ketone | 1000 | 1000 | 1000 | 1070 | 1670 | 1670 | 1300 | 1490 |
| PBDP1 | 2800 | 2800 | 3930 | 2800 | — | — | — | — |
| Fyroflex RDP | — | — | — | — | 1240 | 1240 | — | — |
| Fyroflex TPP | — | — | — | — | — | — | 937 | — |
| Fyroflex BDP | — | — | — | — | — | — | — | 1240 |
| Benzoxazine | — | 600 | — | — | — | — | — | — |
| phosphate | | | | | | | | |
| (Formula 16) | | | | | | | | |
| BZ-4 | 930 | 930 | 830 | 1105 | 100 | 100 | — | 100 |
| LA-7751 | 1300 | 1600 | 1570 | 1600 | 1184 | 1184 | 1256 | 1256 |
| Aluminum | 2400 | — | 1400 | 1155 | 1260 | 2520 | 2530 | 2700 |
| hydroxide | | | | | | | | |
| (CL-303) | | | | | | | | |
| Silicone dioxide | — | 2700 | 1400 | 2310 | 1260 | — | — | — |
| (SilverBond 925) | | | | | | | | |
| Nitrogen | 1.59% | 1.84% | 1.61% | 1.71% | 1.25% | 1.25% | 1.44% | 1.39% |
| content* | | | | | | | | |
| Phosphorous | 1.69% | 1.70% | 2.12% | 1.49% | 1.65% | 1.65% | 1.24% | 1.44% |
| content* | | | | | | | | |
| Inorgnic filler | 26.65% | 27.27% | 26.70% | 34.00% | 31.10% | 31.10% | 35.15% | 34.9% |
| content [symbol] | | | | | | | | |

Varnish Properties

| | | | | | | | | |
|---|---|---|---|---|---|---|---|---|
| Gel time at | 230 sec | 200 sec | 220 sec | 190 sec | 300 sec | 300 sec | 280 sec | 280 sec |
| 171 ± 0.5□ | | | | | | | | |

Prepreg Properties

| | | | | | | | | |
|---|---|---|---|---|---|---|---|---|
| Rest gel time at | 110 sec | 90 sec | 100 sec | 95 sec | 105 sec | 100 sec | 90 sec | 90 sec |
| 171 ± 0.5□ | | | | | | | | |
| Minimum melt | 580 cps | 600 cps | 550 cps | 650 cps | 370 cps | 380 cps | 320 cps | 420 cps |
| viscosity at 105-115□ | | | | | | | | |

Copper clad laminate properties

| | | | | | | | | |
|---|---|---|---|---|---|---|---|---|
| Thickness (mm) | 1.50-1.60 | 1.50-1.60 | 1.50-1.60 | 1.50-1.60 | 1.43-1.52 | 1.43-1.52 | 1.42-1.52 | 1.46-1.55 |
| T_{g} | 147□ | 151□ | 142□ | 159□ | 150□ | 143□ | 141□ | 143□ |
| Peeling strength | 8.8 lb/in | 8.8 lb/in | 8.8 lb/in | 8.8 lb/in | 8.8 lb/in | 8.8 lb/in | 8.8 lb/in | 8.8 lb/in |
| of copper foil | | | | | | | | |
| Solder bath | 150 sec | 300 sec | 170 sec | 270 sec | 200 sec | 100 sec | 90 sec | 120 sec |
| resistance at 288□ | | | | | | | | |
| before pressure | | | | | | | | |
| cooker test | | | | | | | | |
| Solder bath | >50 sec | >50 sec | 30 sec | >50 sec | >50 sec | 30 sec | 10 sec | 20 sec |
| resistance at 288□ | | | | | | | | |
| after pressure | | | | | | | | |
| cooker test | | | | | | | | |
| Heat resistance | 10 min | 21 min | 20 min | 20 min | 12 min | 8 min | 4 min | 8 min |
| at 288□ (TMA) | | | | | | | | |
| Flame retardant | V0 | V0 | V0 | V0 | V1 (not | V0 | V0 | V0 |
| testing (UL 94 | | | | | qualified) | | | |
| level, V0 is | | | | | | | | |
| qualified) | | | | | | | | |

*Phosphorous and nitrogen content are based on total composition (Resin and Inorganic filler). [symbol]
Inorganic filler content is based on total composition (Resin and Inorganic filler)

TABLE 2

| Method | IPC standards |
|---|---|
| Gel time at 171 ± 0.5□ | IPC-TM-650-2.3.18 |
| Rest gel time at 171 ± 0.5□ | IPC-TM-650-2.3.18 |
| Peeling strength of copper foil | IPC-TM-650-2.4.8 |
| Flame retardant testing (UL 94 level) | IPC-TM-650-2.3.10 |

In addition to IPC standards, the invention also adopts other measurements as follows:

Solder Bath Resistance at 288° C.

A 50 mm*100 mm copper clad laminate was dipped in a 288° C. soldering pot to measure the time of delamination or bubbling.

Heat Resistance at 288° C. (TMA)

A 1 mm*1 mm copper clad laminate was charged in a thermal mechanical analyzer (TMA), and the temperature of the TMA was risen from room temperature to 288° C. with a heating rate of 10° C./minute. Large dimensional change of the copper clad laminate means delamination. After the TMA temperature reached 288° C., the time of delamination was measured.

As shown in Table 1, the prepregs of Examples (adopting phosphates having phenol or benzoxazine groups) have higher viscosity than prepregs of Comparative Examples (adopting conventional phosphates). In addition, the copper clad laminate of the Examples have higher Tg, thicker thickness, and better heat resistance than that of the Comparative Examples.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A halogen-free flame retardant epoxy resin composition, comprising:
(a) 25 to 45 weight percent of novolac epoxy resin;
(b) 18 to 35 weight percent of phosphate;
(c) 10 to 20 weight percent of nitrogen-containing phenolic resin, comprising amino triazine novolac resin, benzoxazine resin, or combinations thereof; and
(d) 20 to 45 weight percent of inorganic filler;
wherein the phosphate has formulae: 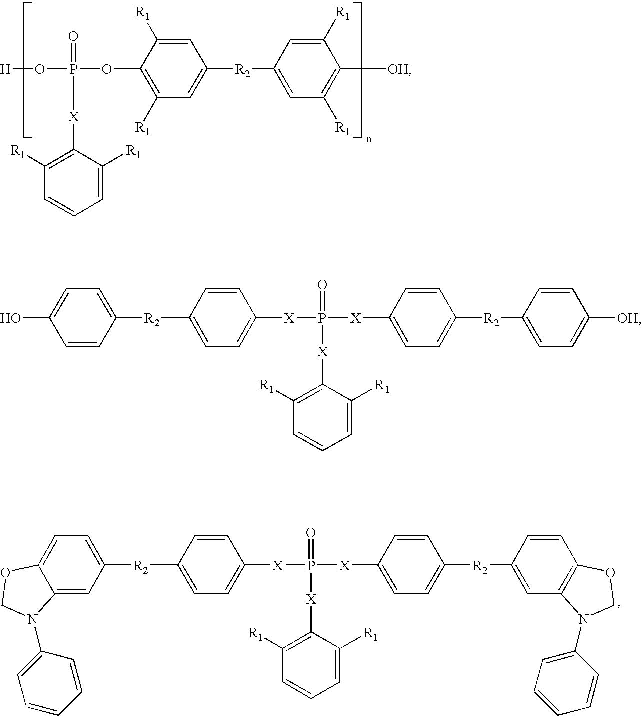
or combinations thereof;
wherein n is an integral from 4 to 10;
each R₁ is independently selected from hydrogen or methyl;
each R₂ is independently selected from isopropyl or sulfonyl; and
each X is independently selected from oxygen or single bond.

2. The epoxy resin composition as claimed in claim 1, wherein the novolac epoxy resin occupies 30 to 40 weight percent of the epoxy resin composition.

3. The epoxy resin composition as claimed in claim 1, wherein the phosphate has a phosphorous content of 1.40 to 2.73 weight percent of the epoxy resin composition.

4. The epoxy resin composition as claimed in claim 1, wherein the phosphate has a phosphorous content of 1.40 to 2.34 weight percent of the epoxy resin composition.

5. The epoxy resin composition as claimed in claim 1, wherein the nitrogen-containing phenolic resin has a nitrogen content of 1.40 to 2.80 weight percent of the epoxy resin composition.

6. The epoxy resin composition as claimed in claim 1, wherein the nitrogen-containing phenolic resin has a nitrogen content of 1.50 to 2.52 weight percent of the epoxy resin composition.

7. The epoxy resin composition as claimed in claim 1, wherein the inorganic filler occupies 25 to 36 weight percent of the epoxy resin composition.

8. The epoxy resin composition as claimed in claim 1, wherein the inorganic filler comprises silicone dioxide, aluminum hydroxide, magnesium hydroxide, aluminum oxide, clay, or mica.

9. The epoxy resin composition as claimed in claim 1, further comprising a bisphenol A epoxy resin occupying less than 5 weight percent of the epoxy resin composition.

10. The epoxy resin composition as claimed in claim 9, wherein the bisphenol A epoxy resin has an epoxy equivalent value less than or equal to 1000.

11. The epoxy resin composition as claimed in claim 1, wherein the novolac epoxy resin has a softening point of 70° C. to 130° C.

12. The epoxy resin composition as claimed in claim 1, wherein the novolac epoxy resin has a softening point of 75° C. to 100° C.

13. The epoxy resin composition as claimed in claim 1, wherein the epoxy group of the epoxy resin composition and the hydroxyl group of the nitrogen-containing phenolic resin have a ratio of 1:0.3 to 1:1.1.

14. The epoxy resin composition as claimed in claim 1, wherein the epoxy group of the epoxy resin composition and the hydroxyl group of the nitrogen-containing phenolic resin have a ratio of 1:0.4 to 1:0.8.

15. The epoxy resin composition as claimed in claim 1, wherein the benzoxazine resin comprises benzoxazine of bisphenol A resin, benzoxazine of bisphenol F resin, benzoxazine of bisphenol sulfonyl resin, benzoxazine of novolac resin, or combinations thereof.

16. The epoxy resin composition as claimed in claim 1, wherein the phosphate has a viscosity of 20000 to 25000 cps at 100° C.

17. The epoxy resin composition as claimed in claim 1, wherein the phosphate has a formula:

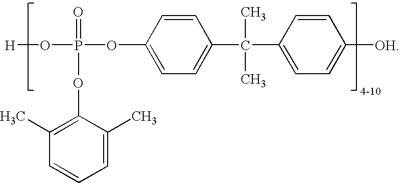

18. The epoxy resin composition as claimed in claim 1, wherein the phosphate has a formula:

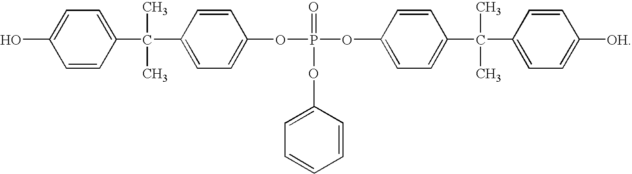

19. The epoxy resin composition as claimed in claim 1, wherein the phosphate has a formula:

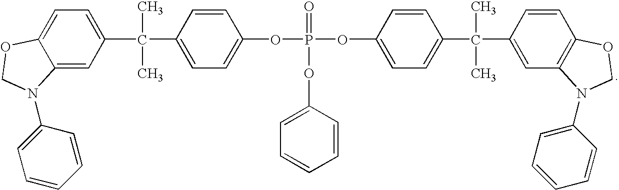

20. A prepreg prepared by impregnating a prepreg to the epoxy resin composition as claimed in claim 1.

21. A copper clad laminate prepared by laminating a copper foil and the prepreg as claimed in claim 20.
